(19) United States
(12) Patent Application Publication
(10) Pub. No.: US 2025/0284479 A1
(43) Pub. Date: Sep. 11, 2025

(54) CENTRAL ADMINISTRATIVE FLEET MANAGEMENT SYSTEM FOR UPDATING IN-FLIGHT ENTERTAINMENT AND COMMUNICATIONS SOFTWARE

(71) Applicant: Panasonic Avionics Corporation, Irvine, CA (US)

(72) Inventors: Attila SZILAGYI, Santa Ana, CA (US); Jonathan BUSH, Santa Ana, CA (US)

(21) Appl. No.: 18/598,923

(22) Filed: Mar. 7, 2024

(51) Int. Cl. G06F 8/65

(52) U.S. Cl. CPC G06F 8/65

(57) ABSTRACT

Systems, devices, and methods updating in-flight entertainment and communications (IFEC) systems in aircraft are disclosed herein. In some implementations, a central administrative fleet management system includes a database configured to store an aircraft installation plan and a managing processor operably coupled to the database. The aircraft installation plan can define a planned set of software content to be stored on an IFEC system of a particular aircraft. The managing processor can be configured to receive an identity of the aircraft, identify a portion of the aircraft installation plan corresponding to the aircraft based on the received identity of the aircraft, and communicate the identified portion of the aircraft installation plan to the IFEC system. The IFEC system can then be updated using software content received from a portable content loader operably coupled to the IFEC system based on the identified portion of the aircraft installation plan.

### TECHNICAL FIELD

This disclosure is directed generally to systems, methods, and devices for updating in-flight entertainment and communications software.

### BACKGROUND

Air travel typically involves journeys over extended distances that at the very least take several hours to complete. Airlines thus often accommodate its customers with in-flight entertainment and communications (IFEC) systems that provide movies, TV shows, music, games, flight tracking, and other programs for passengers to interact with during the flight. Ideally, IFEC systems are updated frequently such that airplanes can always carry the latest and most popular multimedia content. However, updating IFEC systems conventionally requires maintenance personnel or others to physically carry a storage device containing such multimedia content onto the airplane, and to manually transfer select content to the airplane. This can be a labor-intensive and time-consuming process that prohibits frequent updating. Accordingly, there is a need in the art for updating aircraft IFEC systems with software updates, recent media content, etc. in a faster, more efficient, and more reliable manner.

### BRIEF DESCRIPTION OF THE DRAWINGS

Features, aspects, and advantages of the presently disclosed technology may be better understood with regard to the following drawings.

FIG. 1 shows an example of an in-flight entertainment and communications (IFEC) system installed in an airplane based on some implementations of the disclosed technology.

FIG. 2 shows an example block diagram of a computing device based on some implementations of the disclosed technology.

FIG. 3 is a schematic diagram of an environment in which an IFEC system can be updated based on some implementations of the disclosed technology.

FIG. 4 is a schematic diagram of an example process of updating an IFEC system based on some implementations of the disclosed technology.

FIG. 5 is a flowchart illustrating a method for updating IFEC software based on some implementations of the disclosed technology.

A person skilled in the relevant art will understand that the features shown in the drawings are for purposes of illustrations, and variations, including different and/or additional features and arrangements thereof, are possible.

### DETAILED DESCRIPTION

Various implementations of the disclosed technology provide techniques for automating the process of updating software content in in-flight entertainment and communications (IFEC) systems and devices on airplanes. Air travel typically involves journeys over extended distances that at the very least take several hours to complete. Some of the longer non-stop international flights have scheduled durations of over sixteen hours with travel distances extending beyond ten thousand miles. Passengers on board the aircraft are confined within an enclosed space of a designated seat for the entire duration of the flight, with only a few limited opportunities to leave the seat for use of the lavatory and so forth. Thus, even on the shortest trips an airline passenger has some idle time, which the passenger may occupy with work, leisure, and/or rest.

Many passengers bring their own personal electronic devices such as smart phones, media players, electronic readers, tablets, laptop computers, and so forth, for the express purpose of keeping occupied, but airlines also accommodate its customers with in-flight entertainment and communications (IFEC) systems. Although the specific installation may vary depending on the service class, each passenger seat is equipped with a display device, an audio output modality, an input modality such as a remote control, and a terminal unit. Generally, the terminal unit may generate video and audio signals, receive inputs from the remote control, and execute pre-programmed instructions in response thereto. The display device is typically an LCD screen that is installed on the seatback of the row in front of the passenger, though in some cases it may be mounted to a bulkhead or retractable arm or the like that is in turn mounted to the passenger's seat. Furthermore, the audio output modality is a headphone jack, to which a headphone, either supplied by the airline or by the passenger, may be connected.

Via the display and the audio outputs, a wide variety of multimedia content can be presented to the passenger. Recently released movies are a popular viewing choice, as are television shows such as news programs, situation and stand-up comedies, documentaries, and so on. Useful information about the destination such as airport disembarking procedures, immigration and custom procedures and the like is also frequently presented. Audio-only programming is also available, typically comprised of playlists of songs fitting into a common theme or genre. Likewise, video-only content such as flight progress mapping, flight status displays, and so forth are available. Many in-flight entertainment systems also include video games that may be played by the passenger using the remote control, which may also have alternative uses, namely, for navigating through the vast multimedia content library and making selections thereof for viewing and/or listening. Thus, the terminal unit may also include a content selection application with a graphical user interface, through which such navigation of the multimedia content library is possible. The foregoing types of programming that can be presented to the passenger via the in-flight entertainment system will henceforth be generally referred to as multimedia content.

The multimedia content is encoded and stored as digital data, with a video decoder and audio decoder of the terminal unit functioning to generate the aforementioned video and audio signals therefrom. It is desirable to have a wide range of different multimedia content to satisfy the varying tastes of passengers. It is also desirable to have a sufficient volume of multimedia content so that passengers can remain occupied with entertainment for the entire duration of the flight. Accordingly, the multimedia content stored onboard the aircraft can range in the hundreds of gigabytes, if not over a terabyte. The majority of the data comprises the video programming, although the audio and video game content may be significant as well. This data is typically not stored on each individual terminal unit, but rather, in a central content server also onboard the aircraft. In this regard, the terminal unit is understood to incorporate networking modalities such as Ethernet to establish data communications with the central content server. Once a particular selection of multimedia content is requested by the passenger via the content selection application, the terminal unit may retrieve the same from the central content server, decode the data, and present it to the passenger.

As important as variety and volume may be in regards to the multimedia content, novelty is as important for airlines to keep its passengers engaged with the in-flight entertainment system, particularly for valuable frequent fliers. Thus, the multimedia content stored on the content server must be frequently updated. Due to the large volume of data involved, a portable content loader that is generally comprised of a hard disk drive, an optical drive, or a solid state drive loaded with the update data is physically carried onboard while the aircraft is on the ground and connected to the central content server. A download or copy process is then initiated, and once complete, the portable content loader is disconnected and removed from the aircraft.

Different aircraft can have different software content requirements and permissions. For example, geographic restrictions, airline licensing agreements, cultural differences, language preferences, the aircraft model, the anticipated in-flight connectivity, the flight schedule, or passenger data associated with a particular aircraft and its flight route may affect what software content, such as flight tracking program, movies, music, TV shows, or the like, should or can be installed. In conventional settings, personnel such as a maintenance technician would reference paperwork and manually confirm what software content is currently on the airplane, what software content needs to be added or removed, in what order any software updates must be made, etc. This can be a labor intensive process that takes a long time and involves significant human decision-making, making the process prone to human errors.

Also in part because of the laborious manual procedures involved, this update process typically takes place on a periodic schedule, preferably during a layover between flights, such as when aircraft maintenance is conducted. It would be desirable for new multimedia content to be made available on a more frequent basis, incorporating programming that may be only days or even a few hours old. Yet, the expense and labor involved with the use of specialized content loader devices may preclude such an aggressive update schedule, and these issues are particularly acute for large fleets of aircraft. Also in part because of the laborious manual procedures involved, this update process can be vulnerable to human errors.

Accordingly, there is a need in the art for updating aircraft IFEC systems with software updates, recent media content, etc. in a faster, more efficient, and more reliable manner. There is also a desire to shift some of the decision-making from personnel to an automated system.

In some implementations of the present technology, a central administrative fleet management system automates much, if not all, of the decision-making involved in the IFEC software content update process. The fleet management system can be ground-based and can maintain an aircraft installation plan that defines what airplanes should be storing what software content. Thus, when a particular airplane communicates with the fleet management system, the fleet management system can identity the portion of the aircraft installation plan that corresponds to that particular airplane. The fleet management system can then communicate the identified portion of the aircraft installation plan to the IFEC system on the airplane such that the IFEC system can reference the software content already stored in the IFEC system to determine what software content is missing and what software content needs to be added. by automating the software content update process, the fleet management system can significantly reduce any human errors and increase the overall reliability and speed of the process.

Various implementations will be discussed in detail with reference to the figures below. In the description, the technology is described with respect to aircraft such as commercial planes, but the implementations of the disclosed technology can be applicable to other vehicles such as jets, buses, trains, ships, and other types of passenger vehicles.

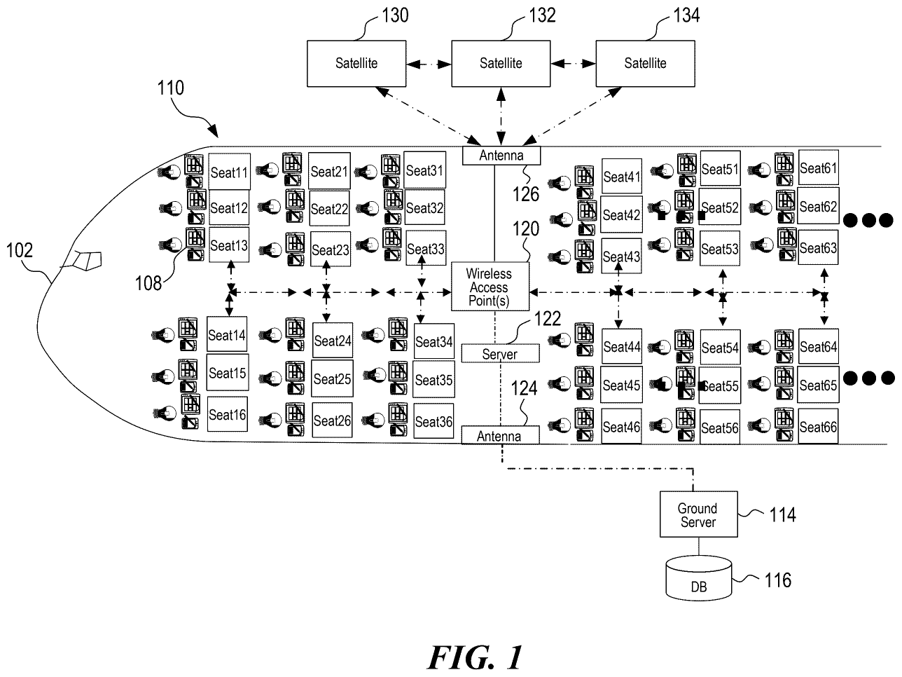

FIG. 1 shows an example of an in-flight entertainment and communications (IFEC) system 110 installed in an airplane 102 based on some implementations of the disclosed technology. The IFEC system 110 includes a plurality of in-flight entertainment (IFE) devices 108, which can provide various entertainment and connectivity services, including video and audio streaming and Internet communications, to passengers on board. For example, the IFE devices 108 can include such as monitors, handsets, ports for transferring audio/power/data, etc. The IFE devices 108 can also communicate or otherwise interact with personal electronic devices (PEDs) carried by passengers. PEDs may refer to any electronic computing device that includes one or more processors or circuitries for implementing the functions related to data storage, video and audio streaming, wired communications, wireless communications, etc. Examples of the PEDs include cellular phones, smart phones, tablet computers, laptop computers, and other portable computing devices. In implementations of the disclosed technology, PEDs may have the capability to execute application software programs (“apps”) to perform various functions and/or communicate with the IFE devices 108.

In the illustrated embodiment, the passenger seats are individually labeled Seat 11 to Seat 66. In some implementations, the IFE devices 108 are provided at each passenger seat, such as located at each of the seatbacks of the passenger seats, and/or on cabin walls and/or deployable from an armrest for seats located at a bulkhead (i.e., in the first row of a section). The IFE devices 108 can include displays providing interfaces to each passenger through which each passenger enters their selections on the entertainment option, e.g., the particular selections, emergency requests, etc. Upon receiving the selection from the passengers, based on the selections from the passengers, the IFE devices 108 can display entertainment content and travel information.

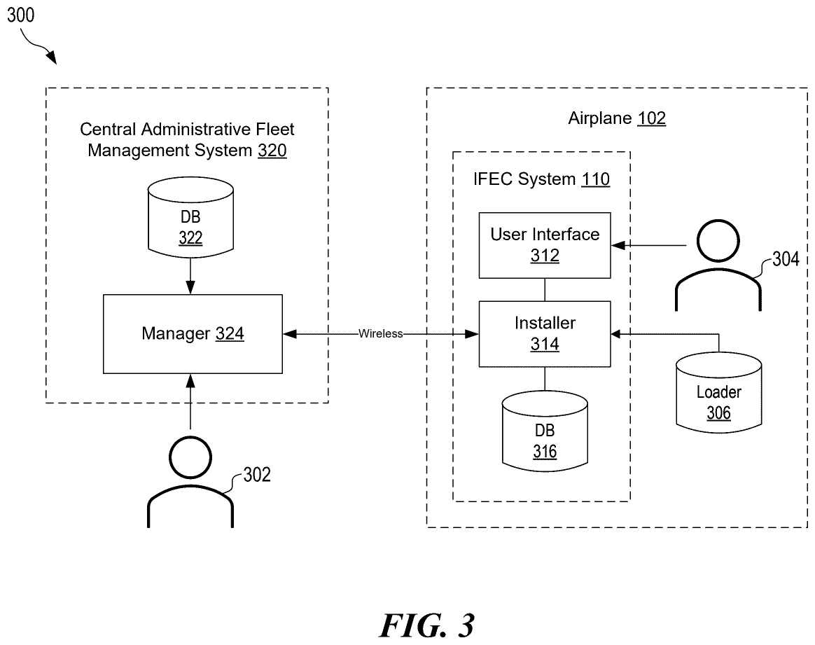

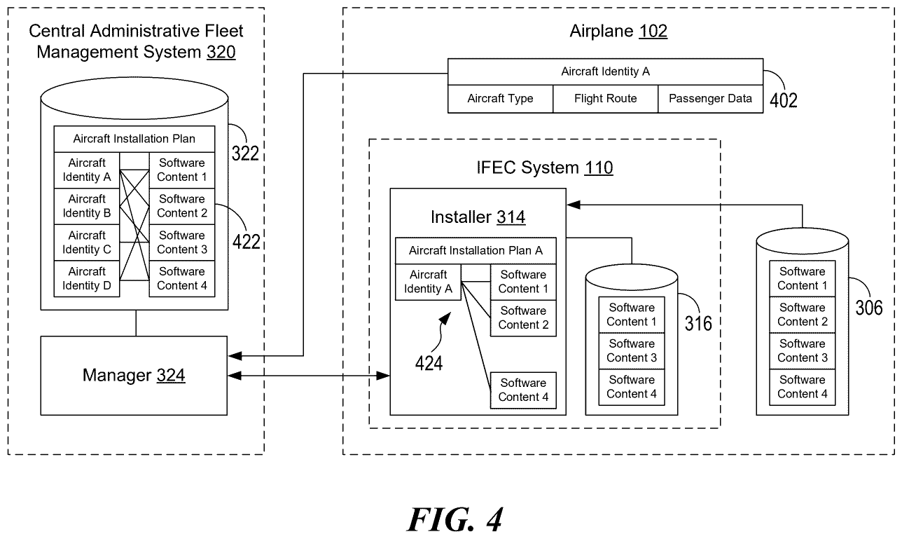

A server 122 can be communicably coupled with the IFE devices 108 and/or the PEDs via one or more wireless access points 120, and perform various operations including updating various software content as discussed with reference to FIGS. 3 and 4. The communications between the server 122, the IFE devices 108, and the PEDs are realized by wired and/or wireless connections. In some implementations, the communication among the server 122, the IFE devices 108, and the PEDs are achieved through the antenna 124 to and from a ground-based server 114 and/or ground-based cell towers by, for example, a provision of network plugs at the seat for the IFE devices 108 to a wired onboard local area network. In some other implementations, the communications among the server 122, the IFE devices 108, and the PEDs are achieved through the antenna 126 to and from satellites 130, 132, 134 in an orbit (e.g., via a cellular network utilizing one or more onboard base station(s), Wi-Fi utilizing the wireless access point 120, and/or Bluetooth).

The server 122, the IFE devices 108, and the PEDs form a local network on board the airplane 102 through an onboard router (not shown). The server 122 is also communicably coupled with the ground server 114 through the antenna 124 for receiving and transmitting information from/to the ground server 114. The ground server 114 can be located at various locations, such as a computer center at an arbitrary location on the ground, etc. The ground server 114 may be in communication with a database 116, provide information from the database 116 to the server 122, and store information received from the server 122 in the database 116. Although FIG. 1 shows that the database 116 is provided separately from the ground server 114, the database 116 can be provided as a part of the ground server 114.

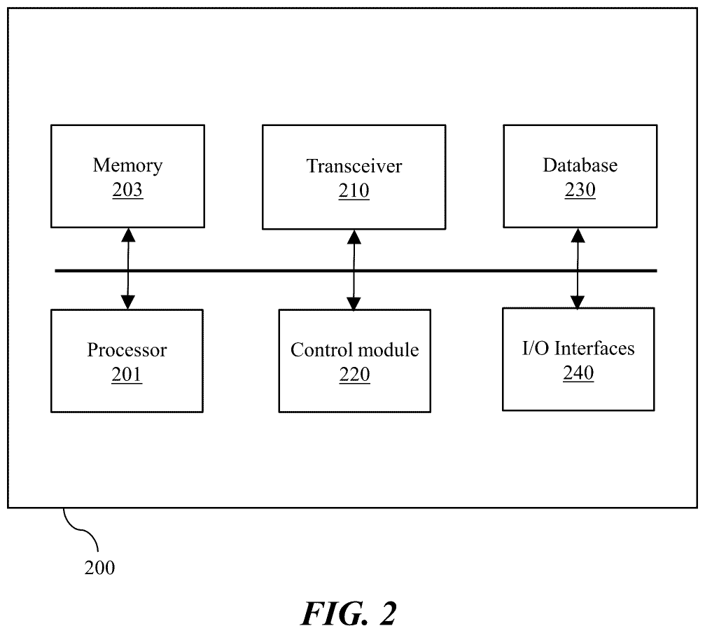

FIG. 2 shows an example block diagram of a computing device 200 (e.g., an onboard server, a ground server, or a portable server) based on some implementations of the disclosed technology. The computing device 200 includes at least one processor 201, a memory 203, a transceiver 210, a control module 220, a database 230, and an input/output (I/O) interface 240. In other embodiments, additional, fewer, and/or different elements may be used to configure the computing device 200. The memory 203 may store instructions and applications to be executed by the processor 201. The memory 203 is an electronic holding place or storage for information or instructions so that the information or instructions can be accessed by the processor 201. The memory 203 can include, but is not limited to, any type of random access memory (RAM), any type of read-only memory (ROM), any type of flash memory, such as magnetic storage devices (e.g., hard disk, floppy disk, magnetic strips, etc.), optical disks (e.g., compact disc (CD), digital versatile discs (DVD), etc.), smart cards, flash memory devices, etc. The instructions upon execution by the processor 201 configure the computing device 200 to perform the operations (e.g., the operations as shown in and described with reference to FIGS. 3-5), which will be described in this patent document. The instructions executed by the processor 201 may be carried out by a special purpose computer, logic circuits, or hardware circuits. The processor 201 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 201 can perform the operations called for by that instruction.

The processor 201 operably couples with the memory 203, the transceiver 210, the control module 220, the database 230, and the I/O interface 240, to receive, send, and process information and to control the operations of the computing device 200. The processor 201 may retrieve a set of instructions from a permanent memory device, such as a ROM device, and copy the instructions in an executable form to a temporary memory device that is generally some form of RAM. In some implementations, the computing device 200 can include a plurality of processors that use the same or a different processing technology. The transceiver 210 may include a transmitter and a receiver. In some embodiments, the device 200 comprises a transmitter and a receiver that are separate from one another but functionally form a transceiver. The transceiver 210 transmits or sends information or data to another device (e.g., the IFE devices 108, a reader device, etc.) and receives information or data transmitted or sent by another device (e.g., another server, a PED, etc.).

The control module 220 of the computing device 200 is configured to perform operations to assist the computing device 200. In some implementations, the control module 220 can be configured as a part of the processor 201. When the computing device 200 communicates with the IFE devices 108 in FIG. 1, the control module 220 can be included in the airplane 102. In some implementations, the control module 220 can operate machine learning/artificial intelligence (AI) applications that perform various types of data analysis to automate analytical model building. Using algorithms that iteratively learn from data, machine learning applications can enable computers to learn without being explicitly programmed. The machine learning/AI module may be configured to use data learning algorithms to build models to interpret various data received from the various devices or components to detect, classify, and/or predict future outcomes. Such data learning algorithms may be associated with rule learning, artificial neural networks, inductive logic programming, and/or clustering. In some implementations, the control module 220 may assist the computing device 200 to perceive their environment and take actions that maximize the effectiveness of the operations performed by the computing device 200.

The I/O interfaces 240 enable data to be provided to the computing device 200 as input and enable the computing device 200 to provide data as output. In some embodiments, the I/O interfaces 240 may enable user input to be obtained and received by the computing device 200 (e.g., via a touch-screen display, buttons, or switches) and may enable the computing device 200 to display information. In some embodiments, devices, including touch screen displays, buttons, controllers, audio speakers, or others, are connected to the computing device 200 via I/O interfaces 240.

In some implementations, the computing device 200 comprises a computer-readable medium (e.g., the memory 203) including processor instructions that, when executed by one or more processors (e.g., the processor 201), cause the one or more processors to perform an IFEC software content update process as described in further detail below with reference to FIGS. 3-5.

FIG. 3 is a schematic diagram of an environment 300 in which the IFEC system 110 can be updated based on some implementations of the disclosed technology. The environment 300 can include the airplane 102, the IFEC system 110 installed on the airplane 102, and a central administrative fleet management system 320 (“the system 320”) offboard the airplane 102. In some implementations, the system 320 is implemented at the ground server 114 and/or the database 116. The environment 300 can also include a manager personnel 302 who can interact with the system 320, and an operations personnel 304 who can interact with the IFEC system 110. As discussed in further detail herein, the system 320 can automate much, if not all, of the decision-making conventionally made by the operations personnel 304.

The IFEC system 110 can include a user interface, an installer 314 operably coupled to the user interface 312, and an IFEC database 316 operably coupled to the installer 314. The user interface 312 can be a graphical user interface (GUI) and/or an audio-based user interface configured to provide information to and receive user inputs from the operations personnel 304. The installer 314 can include a processor or other logic component and/or a communications module. The installer 314 can be configured to exchange data with the user interface 312, the IFEC database 316, and other devices or systems external to the IFEC system 110, as discussed in further detail below. The IFEC database 316 can be configured to store various software content, such as flight-tracking programs and multimedia content (e.g., news, movies, games, etc.). In some implementations, the installer 314 and/or the IFEC database 316 are included in the server 122 illustrated in FIG. 1. In some implementations, the installer 314 and/or the IFEC database 316 are physically or operably separate from the server 122.

The operations personnel 304 can be a maintenance technician or other personnel who physically carries a portable content loader 306 onboard the aircraft 102 and operably couples or otherwise connects the portable content loader 306 to the installer 314 of the IFEC system 110. The portable content loader 306 can include a hard disk drive, an optical drive, or a solid state drive configured to store most, if not all, of the software content, including any software updates, available to the airline or other entity managing the software content to be stored on the IFEC database 316. In some implementations, the connection between the portable content loader 306 and the installer 314 is wired such that any data transfer therebetween remains fast and reliable.

The system 320 can include a manager 324 (also referred to as “the managing processor 324”) and a database 322 operably coupled to the manager 324. The manager 324 can include a processor or other logic component and/or a communications module. The database 322 can be configured to store an aircraft installation plan, which can define a planned set of software content to be stored on the IFEC system 110 of each of a plurality of aircraft 102. Different aircraft can have different software content requirements and permissions, and the aircraft installation plan can list those requirements and permissions for different aircraft. For example, the flight route of a particular aircraft may affect what software content (e.g., flight tracking program, movies, music, TV shows) should be installed (e.g., due to geographic restrictions, airline licensing agreements, cultural differences, language preferences, etc.). In another example, the model of a particular aircraft may affect what software content should be installed (e.g., due to different models of IFE devices 108 installed on the airplane 102, as they may have monitors of varying dimensions that require movies to be formatted differently). In yet another example, the anticipated in-flight connectivity and/or the flight schedule may affect what software content should be installed (e.g., a minimal anticipated in-flight connectivity may require more multimedia content to be uploaded to the IFEC system 110, whereas a tight flight schedule may prohibit large data transfers that may take long periods of time). In yet another example, data associated with passengers who will be on the airplane 102 may affect what software content should be installed (e.g., certain passengers may be known to have certain movie preferences). Therefore, the aircraft installation plan can be based on at least one of airline licensing agreements, geographic restrictions, language preferences, anticipated in-flight connectivity, aircraft model, passenger data, or flight schedule. In some implementations, the aircraft installation plan can additionally define a proper sequence in which any software content or updates should be uploaded to the IFEC system 110.

In some implementations, the manager 324 can automatically generate and routinely update the aircraft installation plan stored on the database 322. For example, the manager 324 can keep track of the airline's licensing agreements, concurrent geographic restrictions, passenger information, etc. to generate an up-to-date aircraft installation plan. In some implementations, the manager personnel 302 can assist the manager 324 with generating the aircraft installation plan and/or approve the aircraft installation plan generated by the manager 324. For example, the system 320 can include a user interface (not shown) that the manager personnel 302 can use to view, edit, and/or approve the aircraft installation plan.

Once the aircraft installation plan has been approved, the manager 324 can communicate with the airplane 102 (e.g., the IFEC system 110) to receive an identity of the aircraft. The manager 324 can then cross-reference the received identity with the aircraft installation plan, which can include planned sets of software content for multiple airplanes, to identity a portion of the aircraft installation plan that corresponds to the particular airplane 102 and communicate it to the installer 314 of the IFEC system 110. In some implementations, the communication between the manager 324 and the installer 314 can be wireless, such as via a Wi-Fi network, a cellular communication network, or a satellite connectivity network.

When the airplane 102 is on the ground, such as during a layover between flights or when aircraft maintenance is conducted, the operations personnel 304 can physically carry the portable content loader 306 onboard the airplane 102. The operations personnel 304 can then connect the portable content loader 306 to the installer 314 of the IFEC system 110. The IFEC system 110 can then initiate a software content update process. In some implementations, the installer 314 configures the user interface 312 to prompt the operations personnel 304 to confirm whether the software content update process should begin.

First, the installer 314 can communicate with (e.g., read) the IFEC database 316 to perform an inventory check to determine the software content currently stored onboard the airplane 102 (also referred to as “the initial set of software content”). The installer 314 can then cross-reference the initial set of software content currently stored in the IFEC database 316 with the planned set of software content defined in the portion of the aircraft installation plan received from the manager 324. In some implementations, the user interface 312 is configured to inform the operations personnel 304 of any differences between the initial set of software content and the planned set of software content. In other implementations, the installer 314 proceeds without such communication to the operations personnel 304. If any software content is missing in the database 316, as defined by the portion of the aircraft installation plan, the installer 314 can transfer the missing software content from the portable content loader 306 to the IFEC database 316. If any software content that should not be in the IFEC database 316, as defined by the portion of the aircraft installation plan, is currently in the IFEC database 316, the installer 314 can delete or remove such software content accordingly. In some implementations, the software content update process can be performed according to the proper sequence defined by the portion of the aircraft installation plan.

Once the software content update process has been completed, the installer 314 can configure the user interface 312 to inform the operations personnel 304 that the process has been completed. The operations personnel 304 can then disconnect (e.g., unplug) the portable content loader 306 from the IFEC system 110 and carry the portable content loader 306 back offboard the airplane 102. In some implementations, the IFEC system 110 can communicate the updated set of software content stored in the IFEC database 316 to the manager 324 or other ground server A more detailed example of a software content update process is illustrated in and described below with reference to FIG. 4.

In some implementations, instead of storing the aircraft installation plan with the system 320, portions of the aircraft installation plan can be embedded in the software content data sets. For example, a particular movie can be embedded with a tag that specifies that the movie should not be on airplanes flying from or to certain countries due to licensing requirements, geographic restrictions, etc. In such implementations, the IFEC system 110 cross-reference the identity of the aircraft with those tags to determine whether certain software content should be added to, removed from, or updated onto the IFEC database 316.

FIG. 4 is a schematic diagram of an example process of updating the IFEC system 110 based on some implementations of the disclosed technology. As shown, the database 322 of the system 320 can store an example aircraft installation plan 422. As discussed above with reference to FIG. 3, the aircraft installation plan 422 can be generated based on at least one of airline licensing agreements, geographic restrictions, language preferences, anticipated in-flight connectivity, aircraft model, or flight schedule. In the illustrated embodiment, the example aircraft installation plan 422 defines planned sets of software content for four different aircraft identities. More specifically, the example aircraft installation plan 422 specifies that (i) airplanes with aircraft identity A should have software contents 1, 2, and 4, (ii) airplanes with aircraft identity B should have software contents 1 and 3, (iii) airplanes with aircraft identity C should have software content 3, and (iv) airplanes with aircraft identity D should have software contents 2 and 4.

The airplane 102 can have an example aircraft identity A 402. The aircraft identity A 402 can include the aircraft model or type, flight route, passenger data, and/or other details specific to the airplane 102. The airplane 102 can communicate the aircraft identity A 402 to the manager 324 of the system 320 via a wireless connection. In some implementations, the aircraft identity A 402 is communicated to the manager 324 by the IFEC system 110. The manager 324 can then reference the received aircraft identity A 402 to identity a portion of the aircraft installation plan 422 that corresponds to the airplane 102 and communicate that portion to the installer 314 of the IFEC system 110 (e.g., via a wireless connection).

As schematically shown within the installer 314 in FIG. 4, the portion 424 of the aircraft installation plan 422 defines a planned set of software content for the airplane 102, namely software contents 1, 2, and 4. The installer 314 can then read the list of software content currently on the IFEC database 316 (e.g., the initial set of software content). For example, in the illustrated embodiment, the IFEC database 316 includes software contents 1, 3, and 4. Therefore, upon cross-referencing the initial set of software content on the IFEC database 316 with the planned set of software content, the installer 314 can determine that the IFEC database 316 needs software content 2 and should not have software 3. For example, software content 2 can be a movie produced in the current destination country that is expected to be in demand by the upcoming group of passengers but was likely foreign to most of the passengers on the previous flight, and software content 3 can be a movie that is restricted by the current destination country. Therefore, in response to such determinations, the installer 314 can automatically delete or remove software content 3 from the IFEC database 316 and upload software content 2 from the portable content loader 306 to IFEC database 316. As shown schematically, the portable content loader 306 can include all of software contents 1, 2, 3, and 4 such that the portable content loader 306 is ready to upload any software content needed by the IFEC system 110. In some implementations, the IFEC system 110 can inform the operations personnel 304 of any or all of the steps taken or to be taken.

By automating much, if not all, of the decision-making of what software content should be added to, removed from, or updated on the IFEC database 316 for a particular airplane 102, the central administrative fleet management system 320 can eliminate or at least significantly reduce the risk of human errors that are normally expected when the operations personnel 304 is making those decisions. For example, automating the software content update process in accordance with implementations of the present technology can reduce the risk of redundancy in software content, since the installer 314 cross-references the portion 424 of the aircraft installation plan 422 and performs an inventory check of what software content is already present in the IFEC database 316. The system 320 can also increase the overall reliability and reduce the overall time for the software content update process compared to conventional settings in which the operations personnel 304 would rely on paperwork to verify inventory and perform data transfers manually.

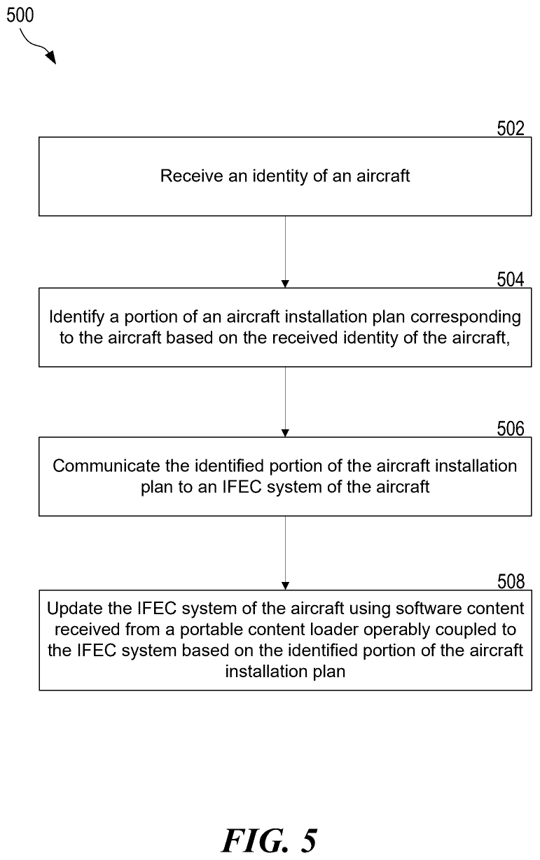

FIG. 5 is a flowchart illustrating a method 500 for updating IFEC software based on some implementations of the disclosed technology. While the method 500 is described below with respect to the implementations described in FIGS. 1-4, one of ordinary skill in the art will appreciate that the method 500 can be practiced with other implementations. Moreover, the steps of the method 500 described below can be performed in an order different from the order in which they are presented, the method 500 can omit some of the steps described, and the method 500 can include additional steps.

At block 502, the method 500 can include receiving an identity (e.g., the aircraft identity A 402) of an aircraft (e.g., the airplane 102). In some implementations, the identity of the aircraft includes at least one of the aircraft type or model, flight route, passenger data, or flight schedule.

At block 504, the method 500 can include identifying a portion of an aircraft installation plan (e.g., the portion 424 of the aircraft installation plan 422) corresponding to the aircraft based on the received identity of the aircraft. The portion of the aircraft installation plan can define a planned set of software content to be stored on an in-flight entertainment and communications (IFEC) system (e.g., the IFEC system 110) of the aircraft. In some implementations, the identified portion of the aircraft installation plan further defines a planned sequence by which software content is to be uploaded to the IFEC system.

At block 506, the method 500 can include communicating the identified portion of the aircraft installation plan to the IFEC system of the aircraft. In some implementations, the identified portion of the aircraft installation plan is communicated via a wireless connection, such as via Wi-Fi, cellular, or satellite connections. In some implementations, the identified portion of the aircraft installation plan is communicated from a manager of a central administrative fleet management system to an installer of the IFEC system.

At block 508, the method 500 can include updating the IFEC system of the aircraft using software content received from a portable content loader (e.g., the portable content loader 306) operably coupled to the IFEC system based on the identified portion of the aircraft installation plan. In some implementations, updating the IFEC system includes determining that an initial set of software content stored on the IFEC system includes software content not included in the planned set of software content, and in response, removing the software content included in the initial set of software content but not included in the planned set of software content from the IFEC system. In some implementations, updating the IFEC system includes determining that an initial set of software content stored on the IFEC system does not include software content included in the planned set of software content, and in response, uploading the software content included in the planned set of software content but not included in the initial set of software content to the IFEC system from the portable content loader. In some implementations, updating the IFEC system includes uploading software content received from the portable content loader based on the planned sequence.

In some implementations, the method 500 further includes generating the aircraft installation plan based on at least one of airline licensing agreements, geographic restrictions, language preferences, anticipated in-flight connectivity, aircraft model, or flight schedule. In some implementations, the method 500 further includes receiving a plurality of identities of a plurality of aircraft, identifying a plurality of portions of the aircraft installation plan corresponding to the plurality of aircraft based on the received identities of the plurality of aircraft, communicating the identified plurality of portions of the aircraft installation plan to corresponding ones of a plurality of IFEC systems of the plurality of aircraft, and updating the plurality of IFEC systems using software content received from one or more portable content loaders operably coupled to the plurality of IFEC systems based on the plurality of identified portions of the aircraft installation plan.

In accordance with the disclosed technology herein, some embodiments may incorporate technical solutions as provided in the following clauses:

A central administrative fleet management system for updating in-flight entertainment and communications software on an aircraft, the system comprising:
a database configured to store an aircraft installation plan, wherein the aircraft installation plan defines a planned set of software content to be stored on an in-flight entertainment and communications (IFEC) system of the aircraft; and
a managing processor operably coupled to the database, wherein the managing processor is configured to:
   receive an identity of the aircraft;
   identify a portion of the aircraft installation plan corresponding to the aircraft based on the received identity of the aircraft; and
   communicate the identified portion of the aircraft installation plan to the IFEC system of the aircraft,
wherein the IFEC system of the aircraft is configured to be updated using software content received from a portable content loader operably coupled to the IFEC system based on the identified portion of the aircraft installation plan communicated by the managing processor.

The system of any of the clauses herein, wherein the IFEC system of the aircraft comprises:
an IFEC database configured to store an initial set of software content; and
an installer operably coupled to the database of the IFEC system, wherein the installer is configured to:
   receive the identified portion of the aircraft installation plan from the managing processor; and
   update the IFEC database using the software content received from the portable content loader based on the portion of the aircraft installation plan.

The system of any of the clauses herein, wherein the installer of the IFEC system is configured to update the IFEC database by performing at least one of:
removing from the IFEC database, in response to a determination that the initial set of software content stored on the IFEC database includes software content not included in the planned set of software content, the software content included in the initial set of software content but not included in the planned set of software content, or
uploading to the IFEC database, in response to a determination that the initial set of software content stored on the IFEC database does not include software content included in the planned set of software content, the software content included in the planned set of software content but not included in the initial set of software content from the portable content loader.

The system of any of the clauses herein, wherein the aircraft installation plan further defines, for each of a plurality of aircraft, a planned sequence by which software content is to be uploaded to the IFEC system, and wherein the installer of the IFEC system is configured to update the IFEC database by uploading software content received from the portable content loader based on the planned sequence.

The system of any of the clauses herein, wherein the IFEC system of the aircraft further comprises a user interface configured to communicate with personnel onboard the aircraft and carrying the portable content loader, wherein the installer is configured to update the IFEC database in response to an input received by the user interface.

The system of any of the clauses herein, wherein the managing processor is further configured to routinely update the aircraft installation plan stored on the database.

The system of any of the clauses herein, wherein the managing processor is configured to receive the identity of the aircraft from the IFEC system of the aircraft.

The system of any of the clauses herein, wherein the managing processor is configured to communicate the identified portion of the aircraft installation plan to the IFEC system of the aircraft wirelessly via at least one of Wi-Fi, cellular connection, or satellite connection.

The system of any of the clauses herein, wherein the managing processor is configured to:
receive a plurality of identities of a plurality of aircraft;
identifying a plurality of portions of the aircraft installation plan corresponding to the plurality of aircraft based on the received identities of the plurality of aircraft; and
communicate the identified plurality of portions of the aircraft installation plan to corresponding ones of a plurality of IFEC systems of the plurality of aircraft.

The system of any of the clauses herein, wherein the managing processor is further configured to generate the aircraft installation plan.

A method for updating in-flight entertainment and communications software on an aircraft, the method comprising:
receiving an identity of the aircraft;
identifying a portion of an aircraft installation plan corresponding to the aircraft based on the received identity of the aircraft, wherein the portion of the aircraft installation plan defines a planned set of software content to be stored on an in-flight entertainment and communications (IFEC) system of the aircraft;
communicating the identified portion of the aircraft installation plan to the IFEC system of the aircraft; and
updating the IFEC system of the aircraft using software content received from a portable content loader operably coupled to the IFEC system based on the identified portion of the aircraft installation plan.

The method of any of the clauses herein, wherein updating the IFEC system comprises:
determining that an initial set of software content stored on the IFEC system includes software content not included in the planned set of software content; and
removing the software content included in the initial set of software content but not included in the planned set of software content from the IFEC system.

The method of any of the clauses herein, wherein updating the IFEC system comprises:
determining that an initial set of software content stored on the IFEC system does not include software content included in the planned set of software content; and
uploading the software content included in the planned set of software content but not included in the initial set of software content to the IFEC system from the portable content loader.

The method of any of the clauses herein, wherein the identified portion of the aircraft installation plan further defines a planned sequence by which software content is to be uploaded to the IFEC system, and wherein updating the IFEC system comprises uploading software content received from the portable content loader based on the planned sequence.

The method of any of the clauses herein, further comprising:
generating the aircraft installation plan based on at least one of airline licensing agreements, geographic restrictions, language preferences, anticipated in-flight connectivity, aircraft model, or flight schedule.

The method of any of the clauses herein, further comprising:
receiving a plurality of identities of a plurality of aircraft;
identifying a plurality of portions of the aircraft installation plan corresponding to the plurality of aircraft based on the received identities of the plurality of aircraft;
communicating the identified plurality of portions of the aircraft installation plan to corresponding ones of a plurality of IFEC systems of the plurality of aircraft; and
updating the plurality of IFEC systems using software content received from one or more portable content loaders operably coupled to the plurality of IFEC systems based on the plurality of identified portions of the aircraft installation plan.

A computer-readable medium including processor instructions that, when executed by one or more processors, cause the one or more processors to:
receive an identity of an aircraft;
identify a portion of an aircraft installation plan corresponding to the aircraft based on the received identity of the aircraft, wherein the portion of the aircraft installation plan defines a planned set of software content to be stored on an in-flight entertainment and communications (IFEC) system of the aircraft;
communicate the identified portion of the aircraft installation plan to the IFEC system of the aircraft; and
update the IFEC system of the aircraft using software content received from a portable content loader operably coupled to the IFEC system based on the identified portion of the aircraft installation plan.

The computer-readable medium of any of the clauses herein, wherein the processor instructions cause the one or more processors to:
determine that an initial set of software content stored on the IFEC system includes software content not included in the planned set of software content; and
remove the software content included in the initial set of software content but not included in the planned set of software content from the IFEC system.

The computer-readable medium of any of the clauses herein, wherein the processor instructions cause the one or more processors to:
determine that an initial set of software content stored on the IFEC system does not include software content included in the planned set of software content; and
upload the software content included in the planned set of software content but not included in the initial set of software content to the IFEC system from the portable content loader.

The computer-readable medium of any of the clauses herein, wherein the identified portion of the aircraft installation plan further defines a planned sequence by which software content is to be uploaded to the IFEC system, and wherein updating the IFEC system comprises uploading software content received from the portable content loader based on the planned sequence.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this patent document.

1. A central administrative fleet management system for updating in-flight entertainment and communications software on an aircraft, the system comprising:
a database configured to store an aircraft installation plan, wherein the aircraft installation plan defines a planned set of software content to be stored on an in-flight entertainment and communications (IFEC) system of the aircraft; and
a managing processor operably coupled to the database, wherein the managing processor is configured to:
receive an identity of the aircraft;
identify a portion of the aircraft installation plan corresponding to the aircraft based on the received identity of the aircraft; and
communicate the identified portion of the aircraft installation plan to the IFEC system of the aircraft,
wherein the IFEC system of the aircraft is configured to be updated using software content received from a portable content loader operably coupled to the IFEC system based on the identified portion of the aircraft installation plan communicated by the managing processor.

2. The system of claim 1, wherein the IFEC system of the aircraft comprises:
an IFEC database configured to store an initial set of software content; and
an installer operably coupled to the database of the IFEC system, wherein the installer is configured to:
receive the identified portion of the aircraft installation plan from the managing processor; and
update the IFEC database using the software content received from the portable content loader based on the portion of the aircraft installation plan.

3. The system of claim 2, wherein the installer of the IFEC system is configured to update the IFEC database by performing at least one of:
removing from the IFEC database, in response to a determination that the initial set of software content stored on the IFEC database includes software content not included in the planned set of software content, the software content included in the initial set of software content but not included in the planned set of software content, or
uploading to the IFEC database, in response to a determination that the initial set of software content stored on the IFEC database does not include software content included in the planned set of software content, the software content included in the planned set of software content but not included in the initial set of software content from the portable content loader.

4. The system of claim 2, wherein the aircraft installation plan further defines, for each of a plurality of aircraft, a planned sequence by which software content is to be uploaded to the IFEC system, and wherein the installer of the IFEC system is configured to update the IFEC database by uploading software content received from the portable content loader based on the planned sequence.

5. The system of claim 2, wherein the IFEC system of the aircraft further comprises a user interface configured to communicate with personnel onboard the aircraft and carrying the portable content loader, wherein the installer is configured to update the IFEC database in response to an input received by the user interface.

6. The system of claim 1, wherein the managing processor is further configured to routinely update the aircraft installation plan stored on the database.

7. The system of claim 1, wherein the managing processor is configured to receive the identity of the aircraft from the IFEC system of the aircraft.

8. The system of claim 1, wherein the managing processor is configured to communicate the identified portion of the aircraft installation plan to the IFEC system of the aircraft wirelessly via at least one of Wi-Fi, cellular connection, or satellite connection.

9. The system of claim 1, wherein the managing processor is configured to:
receive a plurality of identities of a plurality of aircraft;
identifying a plurality of portions of the aircraft installation plan corresponding to the plurality of aircraft based on the received identities of the plurality of aircraft; and
communicate the identified plurality of portions of the aircraft installation plan to corresponding ones of a plurality of IFEC systems of the plurality of aircraft.

10. The system of claim 1, wherein the managing processor is further configured to generate the aircraft installation plan.

11. A method for updating in-flight entertainment and communications software on an aircraft, the method comprising:
receiving an identity of the aircraft;
identifying a portion of an aircraft installation plan corresponding to the aircraft based on the received identity of the aircraft, wherein the portion of the aircraft installation plan defines a planned set of software content to be stored on an in-flight entertainment and communications (IFEC) system of the aircraft;
communicating the identified portion of the aircraft installation plan to the IFEC system of the aircraft; and
updating the IFEC system of the aircraft using software content received from a portable content loader operably coupled to the IFEC system based on the identified portion of the aircraft installation plan.

12. The method of claim 11, wherein updating the IFEC system comprises:
determining that an initial set of software content stored on the IFEC system includes software content not included in the planned set of software content; and
removing the software content included in the initial set of software content but not included in the planned set of software content from the IFEC system.

13. The method of claim 11, wherein updating the IFEC system comprises:
determining that an initial set of software content stored on the IFEC system does not include software content included in the planned set of software content; and
uploading the software content included in the planned set of software content but not included in the initial set of software content to the IFEC system from the portable content loader.

14. The method of claim 11, wherein the identified portion of the aircraft installation plan further defines a planned sequence by which software content is to be uploaded to the IFEC system, and wherein updating the IFEC system comprises uploading software content received from the portable content loader based on the planned sequence.

15. The method of claim 11, further comprising:
generating the aircraft installation plan based on at least one of airline licensing agreements, geographic restrictions, language preferences, anticipated in-flight connectivity, aircraft model, or flight schedule.

16. The method of claim 11, further comprising:
receiving a plurality of identities of a plurality of aircraft;
identifying a plurality of portions of the aircraft installation plan corresponding to the plurality of aircraft based on the received identities of the plurality of aircraft;
communicating the identified plurality of portions of the aircraft installation plan to corresponding ones of a plurality of IFEC systems of the plurality of aircraft; and
updating the plurality of IFEC systems using software content received from one or more portable content loaders operably coupled to the plurality of IFEC systems based on the plurality of identified portions of the aircraft installation plan.

17. A computer-readable medium including processor instructions that, when executed by one or more processors, cause the one or more processors to:
receive an identity of an aircraft;
identify a portion of an aircraft installation plan corresponding to the aircraft based on the received identity of the aircraft, wherein the portion of the aircraft installation plan defines a planned set of software content to be stored on an in-flight entertainment and communications (IFEC) system of the aircraft;
communicate the identified portion of the aircraft installation plan to the IFEC system of the aircraft; and
update the IFEC system of the aircraft using software content received from a portable content loader operably coupled to the IFEC system based on the identified portion of the aircraft installation plan.

18. The computer-readable medium of claim 17, wherein the processor instructions cause the one or more processors to:
determine that an initial set of software content stored on the IFEC system includes software content not included in the planned set of software content; and
remove the software content included in the initial set of software content but not included in the planned set of software content from the IFEC system.

19. The computer-readable medium of claim 17, wherein the processor instructions cause the one or more processors to:
determine that an initial set of software content stored on the IFEC system does not include software content included in the planned set of software content; and
upload the software content included in the planned set of software content but not included in the initial set of software content to the IFEC system from the portable content loader.

20. The computer-readable medium of claim 17, wherein the identified portion of the aircraft installation plan further defines a planned sequence by which software content is to be uploaded to the IFEC system, and wherein updating the IFEC system comprises uploading software content received from the portable content loader based on the planned sequence.
